(19) United States
(12) Patent Application Publication
(10) Pub. No.: US 2020/0265410 A1
(43) Pub. Date: Aug. 20, 2020

(54) AUTOMATICALLY DELAYING PAYMENT FOR A TRANSACTION FOR AN ITEM UNTIL THE ITEM IS DELIVERED

(71) Applicant: Capital One Services, LLC, McLean, VA (US)

(72) Inventors: Adam Vukich, McLean, VA (US); Joshua Edwards, McLean, VA (US); Abdelkadar M'Hamed Benkreira, McLean, VA (US)

(21) Appl. No.: 16/277,845

(22) Filed: Feb. 15, 2019

(51) Int. Cl. G06Q 20/24; G06Q 10/08; G06Q 20/40; G06Q 30/02

(52) U.S. Cl. CPC G06Q 20/24; G06Q 10/0833; G06Q 10/0835; G06Q 20/405; G06Q 30/0282; G06Q 20/407

(57) ABSTRACT

A device generates an authorization charge for a purchase of an item, where the item is purchased via a user device associated with a customer, and the authorization charge is generated without posting the authorization charge to a record associated with the customer. The device receives, from a merchant device, the user device, or a courier device, information indicating a delivery status of the item, and provides, to the user device, the merchant device, or the courier device, a request to check the delivery status of the item. The device receives, based on the request, information indicating an updated delivery status of the item, and determines that the item was not delivered based on the updated delivery status. The device cancels the authorization charge for the purchase, and requests, from the merchant device, a charge back for the purchase of the item.

### BACKGROUND

More people than ever are shopping online and having items (e.g., products and/or services) delivered to their homes, workplaces, and/or other locations. Many merchants utilize delivery services to deliver the items to the homes, the workplaces, and/or the other locations. However, sometimes items require more than a week to be delivered to a customer (e.g., items that require ground delivery, international delivery, and/or the like).

### SUMMARY

According to some implementations, a method may include generating an authorization charge for a purchase of an item, wherein the item is purchased via a user device associated with a customer, and wherein the authorization charge is generated without posting the authorization charge to a record associated with the customer. The method may include receiving information indicating a delivery status associated with delivering the item to the customer, wherein the information indicating the delivery status is received from one or more of a merchant device associated with a merchant from which the item is purchased, the user device, or a courier device associated with a courier service to deliver the item to the customer. The method may include comparing the information indicating the delivery status received from the merchant device, the user device, or the courier device, and verifying the information indicating the delivery status based on comparing the information indicating the delivery status received from the merchant device, the user device, or the courier device. The method may include providing, to one or more of the user device, the merchant device, or the courier device, a request to check the delivery status of the item, and receiving, based on the request and from the one or more of the user device, the merchant device, or the courier device, information indicating an updated delivery status of the item. The method may include determining that the item was not delivered based on the updated delivery status, and canceling the authorization charge for the purchase without posting the authorization charge to the record associated with the customer. The method may include requesting, from the merchant device, a charge back for the purchase of the item, and receiving, from the merchant device, the charge back for the purchase of the item based on requesting the charge back.

According to some implementations, a device may include one or more memories, and one or more processors operatively connected to the one or more memories and configured to generate an authorization charge for a purchase of an item, wherein the item is purchased via a user device associated with a customer, and wherein the authorization charge is generated without posting the authorization charge to a record associated with the customer. The one or more processors may receive information indicating a delivery status associated with delivering the item to the customer, wherein the information indicating the delivery status is received from one or more of a merchant device associated with a merchant from which the item is purchased, the user device, or a courier device associated with a courier service to deliver the item to the customer. The one or more processors may compare the information indicating the delivery status received from the merchant device, the user device, or the courier device, and may verify the information indicating the delivery status based on comparing the information indicating the delivery status received from the merchant device, the user device, or the courier device. The one or more processors may provide, to one or more of the user device, the merchant device, or the courier device, a request to check the delivery status of the item, and may receive, based on the request and from the one or more of the user device, the merchant device, or the courier device, information indicating an updated delivery status of the item. The one or more processors may selectively perform first actions or a second action based on the updated delivery status of the item, wherein the first actions are performed when the updated delivery status indicates that the item was not delivered and include canceling the authorization charge for the purchase without posting the authorization charge to the record associated with the customer, requesting, from the merchant device, a charge back for the purchase of the item, and receiving, from the merchant device, the charge back for the purchase of the item based on requesting the charge back, and wherein the second action is performed when the updated delivery status indicates that the item was delivered and includes posting the authorization charge to the record associated with the customer.

According to some implementations, a non-transitory computer-readable medium may store instructions that include one or more instructions that, when executed by one or more processors of a device, cause the one or more processors to receive information indicating purchase of an item via a user device associated with a customer, and generate an authorization charge for a purchase of an item, without posting the authorization charge to a record associated with the customer. The one or more instructions may cause the one or more processors to receive information indicating a delivery status associated with delivering the item to the customer, wherein the information indicating the delivery status is received from one or more of a merchant device associated with a merchant from which the item is purchased, the user device, or a courier device associated with a courier service to deliver the item to the customer. The one or more instructions may cause the one or more processors to compare the information indicating the delivery status received from the merchant device, the user device, or the courier device, and verify the information indicating the delivery status based on comparing the information indicating the delivery status received from the merchant device, the user device, or the courier device. The one or more instructions may cause the one or more processors to provide, after a time period and to one or more of the user device, the merchant device, or the courier device, a request to check the delivery status of the item, and receive, based on the request and from the one or more of the user device, the merchant device, or the courier device, information indicating an updated delivery status of the item. The one or more instructions may cause the one or more processors to determine that the item was not delivered based on the updated delivery status, and provide, to the user device, a charge back form, wherein the user device is to utilize the charge back form to request a charge back from the merchant device for the purchase of the item. The one or more instructions may cause the one or more processors to cancel the authorization charge for the purchase without posting the authorization charge to the record associated with the customer, and receive, from the merchant device, the charge back for the purchase of the item based on providing the charge back form to the user device.

### BRIEF DESCRIPTION OF THE DRAWINGS

FIGS. 1A-1J are diagrams of an example implementation described herein.

FIG. 2 is a diagram of an example environment in which systems and/or methods, described herein, may be implemented.

FIG. 3 is a diagram of example components of one or more devices of FIG. 2.

FIGS. 4-6 are flow charts of example processes for automatically delaying payment for a transaction for an item until the item is delivered.

### DETAILED DESCRIPTION

The following detailed description of example implementations refers to the accompanying drawings. The same reference numbers in different drawings may identify the same or similar elements.

When an online purchase is made for an item by a customer from a merchant, an authorization charge (e.g., a pending charge) may be applied to a financial account (e.g., a credit card account) associated with the customer. Typically, two to three days elapse before the authorization charge becomes a posted transaction applied to the financial account of the customer. Once the authorization charge posts, the customer is responsible for paying the charge for the purchased item, even if the item is not received by the customer (e.g., which may occur when the item requires more than a week to be delivered to the customer). Furthermore, if the item is never delivered, the customer is forced to partake in a dispute process with the merchant and/or a financial institution of the customer.

Some implementations described herein provide a charging platform that automatically delays payment for a transaction for an item until the item is delivered. For example, the charging platform may receive information indicating a purchase of an item via a user device associated with a customer, and may generate an authorization charge for the purchase of the item, without posting the authorization charge to a record associated with the customer. The charging platform may receive information indicating a delivery status associated with delivering the item to the customer, where the information indicating the delivery status may be received from one or more of a merchant device associated with a merchant from which the item is purchased, the user device, or a courier device associated with a courier service responsible for delivering the item to the customer. The charging platform may compare the information indicating the delivery status received from the merchant device, the user device, or the courier device, and may verify the information indicating the delivery status based on comparing the information indicating the delivery status received from the merchant device, the user device, or the courier device. The charging platform may provide, after a time period and to one or more of the user device, the merchant device, or the courier device, a request to check the delivery status of the item, and may receive, based on the request and from the one or more of the user device, the merchant device, or the courier device, information indicating an updated delivery status of the item. The charging platform may determine that the item was not delivered based on the updated delivery status, and may provide, to the user device, a charge back form, where the user device may provide the charge back form (e.g., with information filled in by the customer) to the charging platform for requesting a charge back from the merchant device for the purchase of the item. The charging platform may cancel the authorization charge for the purchase without posting the authorization charge to the record associated with the customer, and may receive, from the merchant device, the charge back for the purchase of the item based on providing the charge back form to the user device.

In this way, the charging platform delays posting of an authorization charge to a customer account until an item associated with the authorization charge is delivered to (e.g., physically received by) the customer. This may enable the customer to avoid having to partake in a dispute process with a merchant and/or a financial institution if the item is not delivered to the customer. The charging platform may conserve resources (e.g., processing resources, memory resources, and/or the like) that would otherwise be wasted by posting authorization charges for items that are not delivered, conducting dispute processes for items that are not delivered, and/or the like.

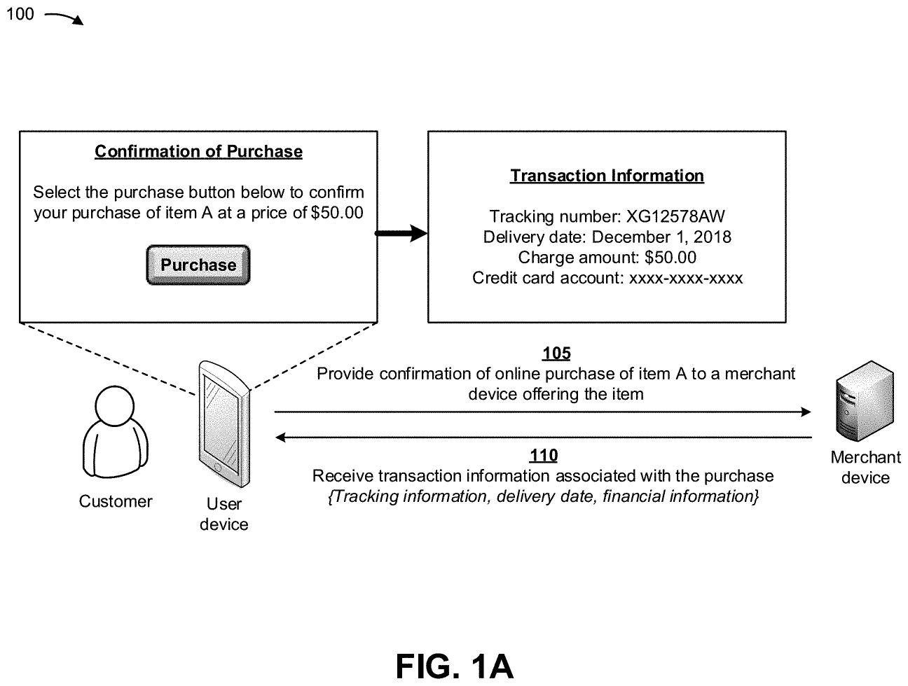

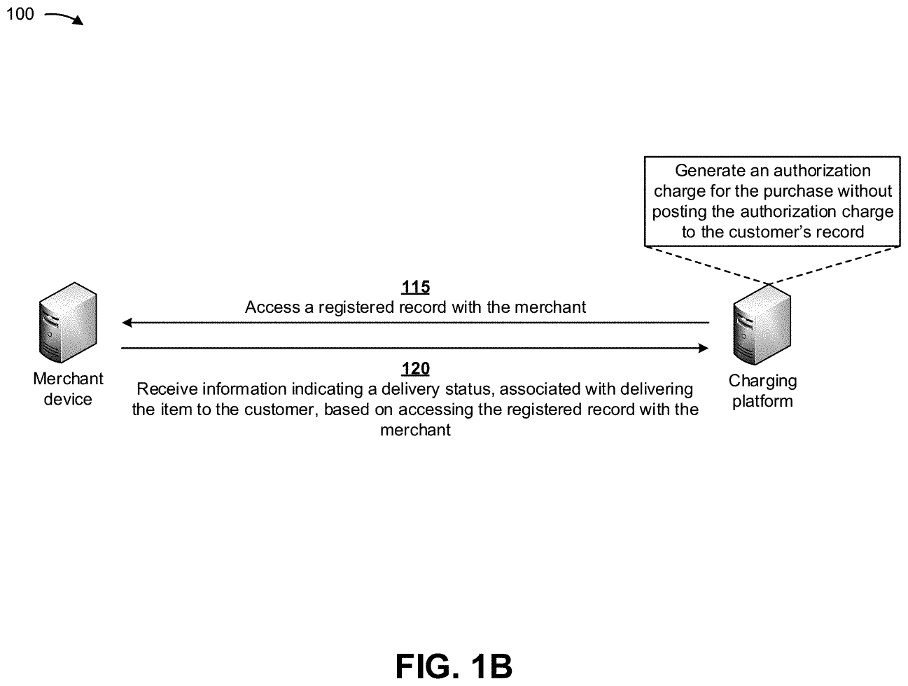

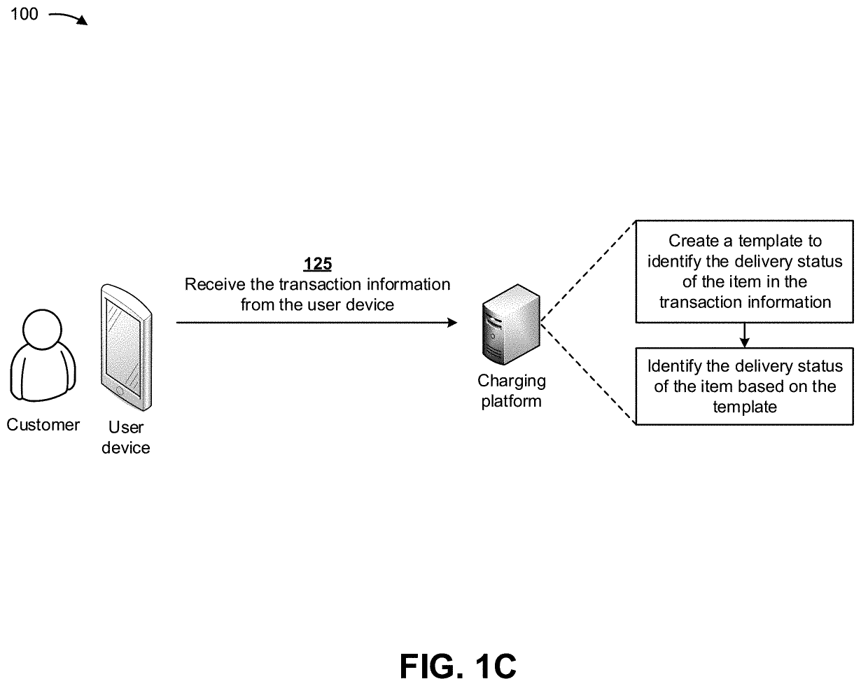

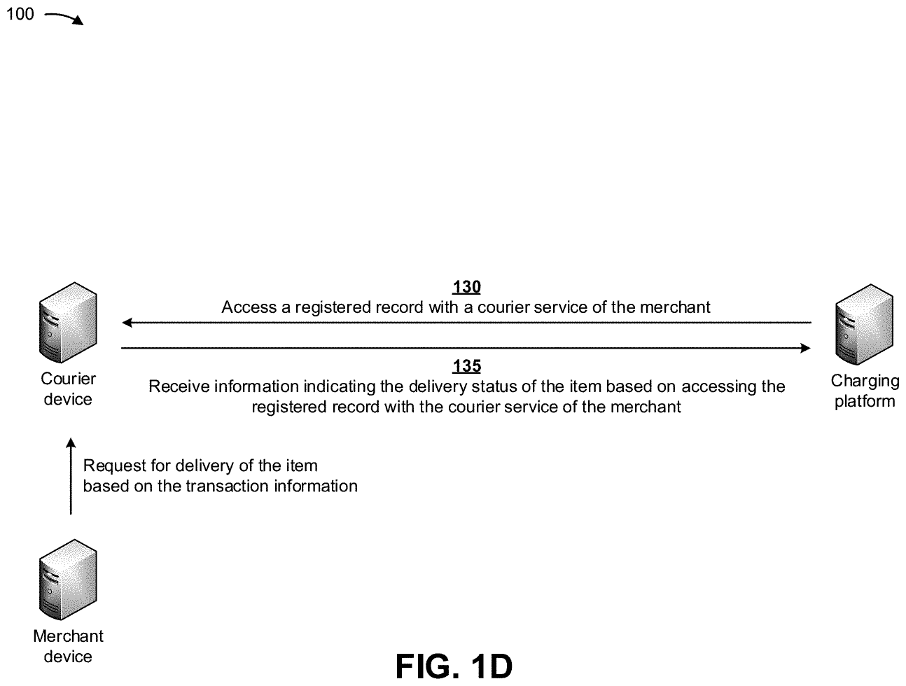

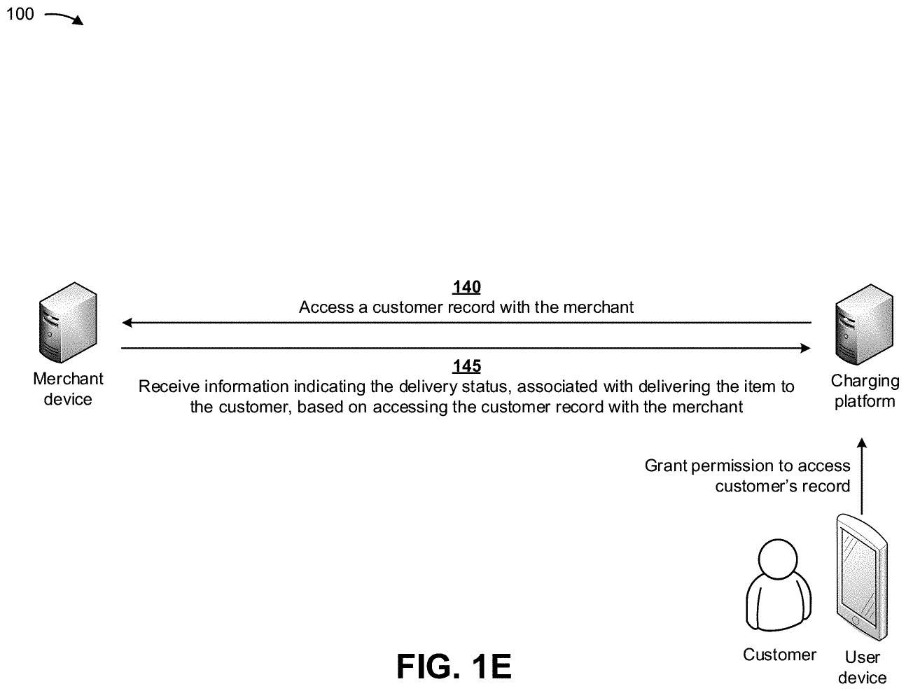

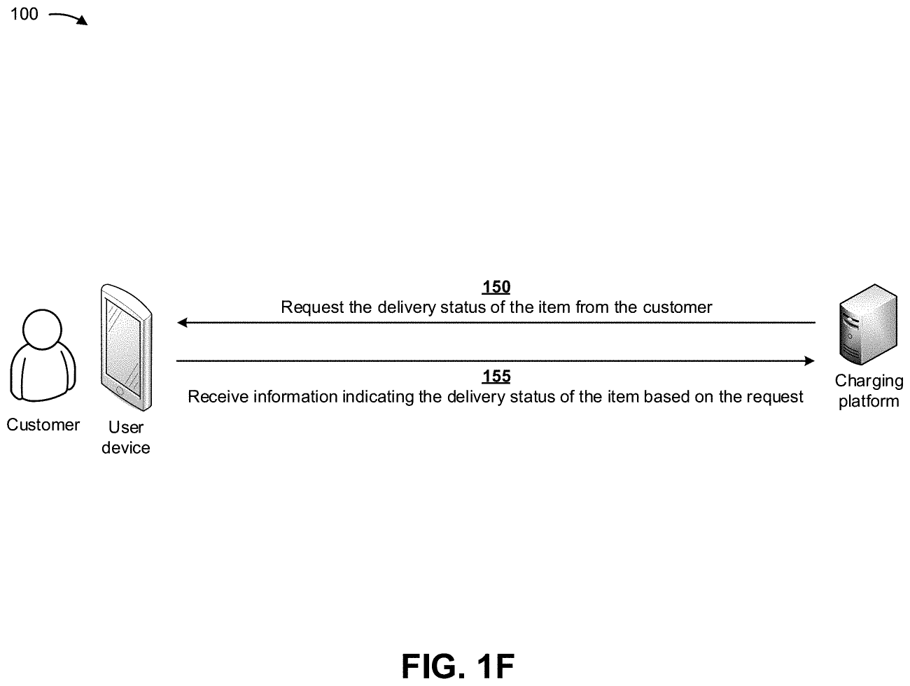

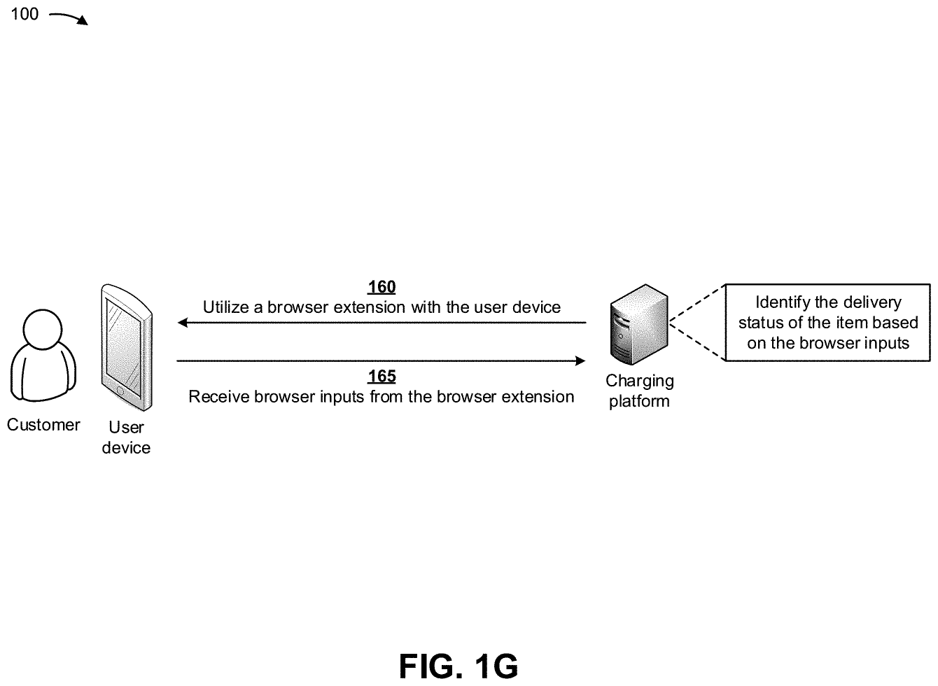

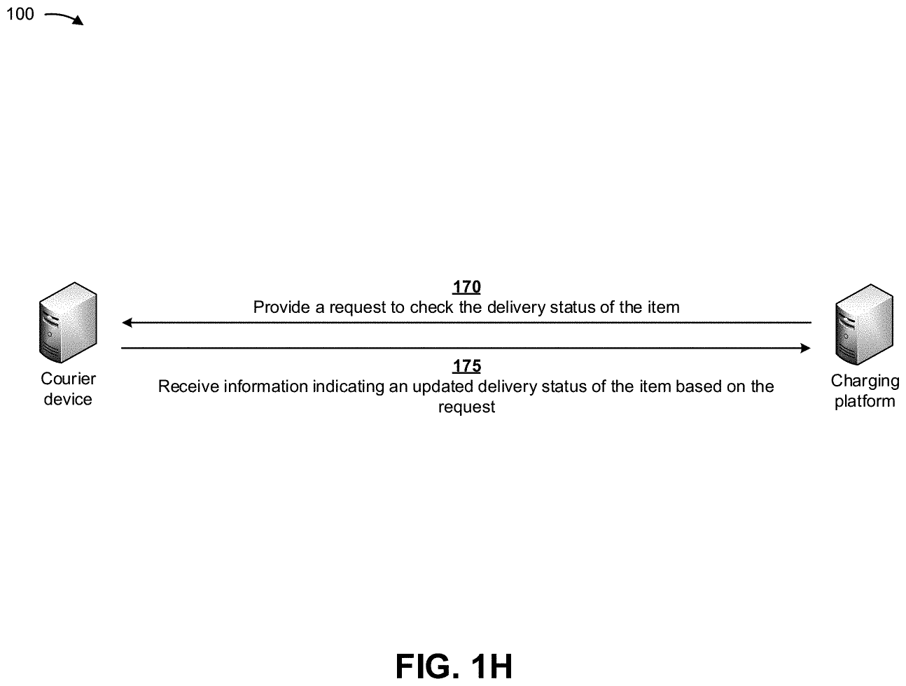

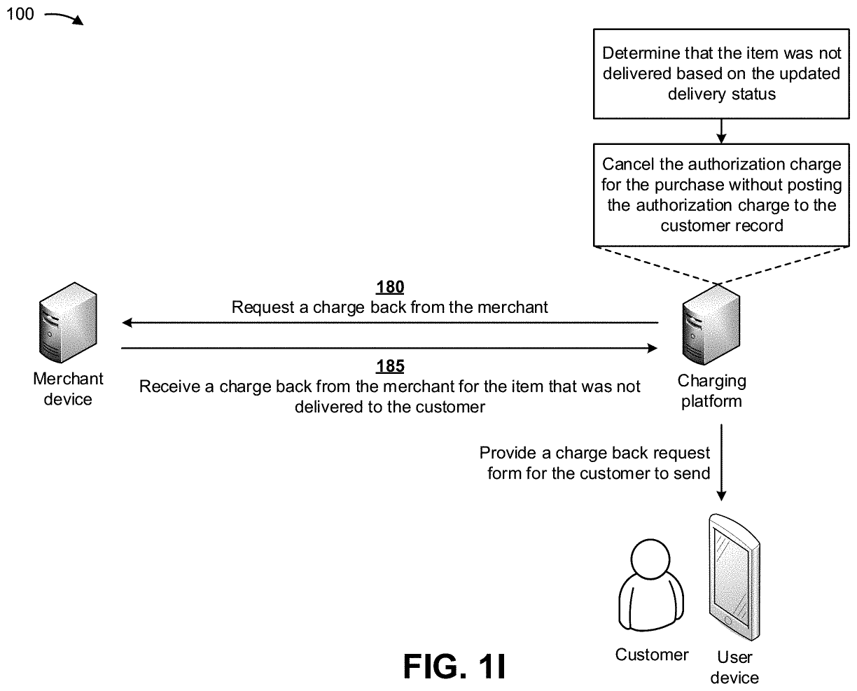

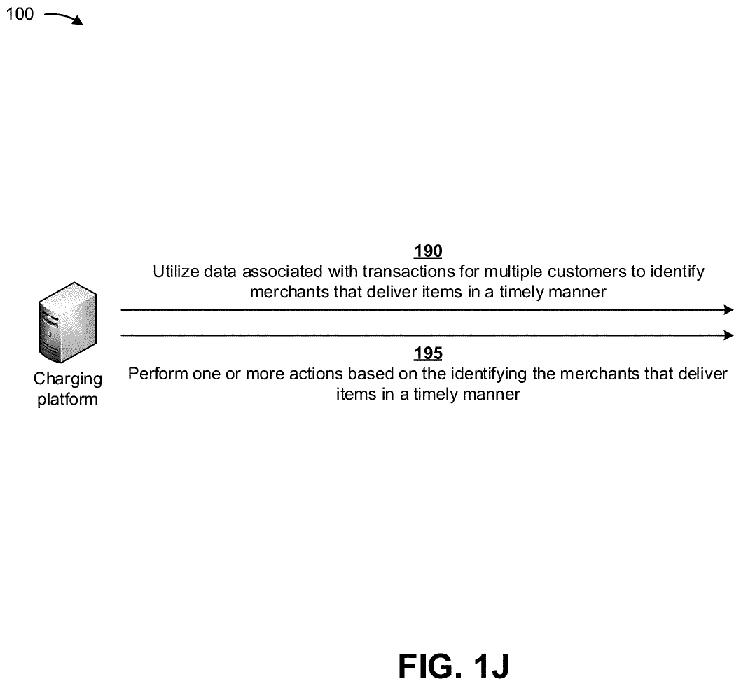

FIGS. 1A-1J are diagrams of an example implementation 100 described herein. As shown in FIGS. 1A-1J, a user device may be associated with a customer, a charging platform, a merchant device (e.g., associated with a merchant selling an item to the customer), and a courier device (e.g., associated with a courier service responsible for delivering the item to the customer). In some implementations, the courier device may be omitted when the merchant is responsible for delivering the item to the customer. As shown in FIG. 1A, the customer may utilize the user device to access the merchant device and to perform an online transaction with the merchant device. In some implementations, the user device may be utilized to select an item offered by the merchant device, and to purchase the item from a merchant associated with the merchant device. As shown in FIG. 1A, once the user utilizes the user device to select the item, the user may utilize the user device to confirm a purchase of the item. For example, the user may utilize the user device to confirm a purchase of item A at a price of $50.00 by selecting a selection mechanism (e.g., a purchase button, icon, link, and/or the like).

As further shown in FIG. 1A, and by reference number 105, when the user selects the selection mechanism, the user device may provide, to the merchant device, confirmation of the online purchase of item A. The merchant device may receive the confirmation of the online purchase, and may provide transaction information associated with the purchase to the user device. As shown in FIG. 1A, and by reference number 110, the user device may receive, from the merchant device, the transaction information associated with the purchase. In some implementations, the transaction information may include information indicating a delivery status of the item (e.g., tracking information, a delivery date, a delivery address, and/or the like), financial information (e.g., information indicating an amount charged to the customer for the item, an account of the customer that is charged for the item, an invoice number for the item, a confirmation number for the item, and/or the like), and/or the like.

In some implementations, the charging platform may obtain information indicating a delivery status associated with delivering the item to the customer in a variety of ways. For example, the charging platform may receive the information indicating the delivery status of the item from the merchant device, the user device, the courier device, and/or the like. In some implementations, the charging platform may receive the information indicating the delivery status of the item from the merchant device, the user device, and/or the courier device, and may compare the delivery status information received from each of the devices. The charging platform may verify the delivery status of the item based on comparing the delivery status information received from each of the devices. For example, if the charging platform receives a first tracking number from the merchant device and a second tracking number from the user device, the charging platform may verify that the first tracking number matches the second tracking number.

In some implementations, the charging platform may assign weights to the delivery status information received from each of the devices. For example, the charging platform may assign a first weight to the delivery status information received from the merchant device since the merchant is the entity providing the item to the customer, may assign a second weight (e.g., that is less than the first weight) to the delivery status information received from the user device since the customer is the entity receiving the item, may assign a third weight (e.g., that is less than the second weight) to the delivery status information received from the courier device since the courier is a third party in the transaction, and/or the like. In such implementations, the charging platform may provide more weight to (e.g., and rely upon) the delivery status information received from the merchant device than the delivery status information received from the user device, may provide more weight to the delivery status information received from the user device than the delivery status information received from the courier device, and/or the like.

Once the transaction occurs, the merchant device may provide the transaction information to the charging platform in order to receive payment for the purchase of the item. As shown in FIG. 1B, when the charging platform receives the transaction information from the merchant device, the charging platform may generate an authorization charge (e.g., a pending charge) for the purchase of the item without posting the authorization charge to a record (e.g., an account) associated with the customer. In this way, the charging platform may prevent the customer record from being charged until the item is delivered to (e.g., received by) the customer.

As further shown in FIG. 1B, and by reference number 115, to receive the delivery status information from the merchant device, the charging platform may access a registered record with the merchant via the merchant device. In some implementations, the charging platform may include credentials (e.g., a user identifier, a password, and/or the like) for the registered record with the merchant, and may access the registered record by providing the credentials to the merchant device. In some implementations, the charging platform may utilize the customer record (e.g., a credit card number, an account number, and/or the like associated with the customer), a dollar amount of the purchase, and/or the like to access the registered record with the merchant.

As further shown in FIG. 1B, and by reference number 120, the charging platform may receive, from the merchant device, information indicating the delivery status, associated with delivering the item to the customer, based on accessing the registered record with the merchant. For example, once the charging platform accesses the registered record, the merchant device may automatically provide the information indicating the delivery status of the item to the charging platform. In some implementations, the merchant device may provide, to the charging platform, an application programming interface (API) that the charging platform may use to provide information to identify the purchase of the item (e.g., a dollar amount, the customer record, and/or the like). In such implementations, the charging platform may utilize the API to provide the information, and may receive the information indicating the delivery status of the item based on providing the information.

As shown in FIG. 1C, and by reference number 125, in order to receive the delivery status information from the user device, the charging platform may receive the transaction information from the user device. In some implementations, the user device may automatically provide the transaction information to the charging platform when the user device receives the transaction information from the merchant device, as described above in connection with FIG. 1A.

In some implementations, and as further shown in FIG. 1C, the charging platform may create a template (e.g., that may be used over again) to identify the delivery status of the item in the transaction information. For example, the charging platform may create a template that identifies a location of the delivery status of the item for the merchant providing the item to the customer. In some implementations, different merchants may provide the transaction information in different formats, and the charging platform may utilize different templates for different merchants in order to identify a delivery status of an item in the transaction information. As further shown in FIG. 1C, the charging platform may identify the delivery status of the item (e.g., from the transaction information) based on the template.

In some implementations, the charging platform may perform natural language processing on the transaction information, and may identify the information indicating the delivery status of the item based on performing the natural language processing on the transaction information. For example, the charging platform may perform natural language processing on the transaction information to generate natural language processing results, and may analyze the natural language processing results to identify information indicating the delivery status of the item. Natural language processing involves techniques performed (e.g., by a computer system) to analyze, understand, and derive meaning from human language in a useful way. Natural language processing can be applied to analyze text, allowing machines to understand how humans speak, enabling real-world applications such as automatic text summarization, sentiment analysis, topic extraction, named entity recognition, parts-of-speech tagging, relationship extraction, stemming, and/or the like.

In some implementations, the charging platform may utilize the natural language processing results to identify merchants that deliver items through a courier service. In some implementations, the charging platform may utilize the natural language processing results to identify information indicating a merchant number (e.g., a tax identification associated with the merchant), and may determine, based on the merchant number, whether the merchant provides items in-person (e.g., at a store, a warehouse, and/or the like) or whether the merchant delivers items (e.g., via a courier service).

In some implementations, the user device may include an application that automatically provides the delivery status of the item to the charging platform. For example, with the permission of the customer, the application may search for the delivery status of the item in an email account of the customer. Such an email might provide additional information, such as information identifying a courier service for the item, an expected delivery date of the item, a current location the item, a tracking number associated with the item, and/or the like. The tracking number may be utilized, by the charging platform, to perform an Internet search for the delivery status of the item.

In some implementations, the merchant associated with the merchant device may utilize a courier service, associated with a courier device, to deliver the item to the customer. For example, as shown in FIG. 1D, the merchant device may provide, to the courier device, a request for delivery of the item to the customer based on the transaction information. The courier device may receive the request and may schedule the item to be delivered to the customer based on the request.

As further shown in FIG. 1D, and by reference number 130, in order to receive the delivery status information from the courier device (e.g., with permission of the merchant and the customer), the charging platform may access a registered record with the courier device via the courier device. In some implementations, the charging platform may include credentials (e.g., a user identifier, a password, and/or the like) for the registered record with the courier service, and may access the registered record by providing the credentials to the courier device. In some implementations, the charging platform may utilize the customer record (e.g., a credit card number, an account number, and/or the like associated with the customer), a dollar amount of the purchase, and/or the like to access the registered record with the courier service.

As further shown in FIG. 1D, and by reference number 135, the charging platform may receive, from the courier device, information indicating the delivery status, associated with delivering the item to the customer, based on accessing the registered record with the courier service. For example, once the charging platform accesses the registered record, the courier device may automatically provide the information indicating the delivery status of the item to the charging platform. In some implementations, the courier device may provide, to the charging platform, an API that the charging platform may use to provide information to identify the purchased item (e.g., a dollar amount, the customer record, and/or the like). In such implementations, the charging platform may utilize the API to provide the information, and may receive the information indicating the delivery status of the item based on providing the information.

In some implementations, the customer may provide, to the charging platform, permission to access the customer record with the merchant. For example, as shown in FIG. 1E, the customer may utilize the user device to grant permission to access the customer record to the charging platform.

As further shown in FIG. 1E, and by reference number 140, in order to receive the delivery status information from the merchant device, the charging platform may access a customer record with the merchant via the merchant device. In some implementations, the charging platform may include credentials (e.g., a user identifier, a password, and/or the like) for the customer record with the merchant, and may access the customer record by providing the credentials to the merchant device.

As further shown in FIG. 1E, and by reference number 145, the charging platform may receive, from the merchant device, information indicating the delivery status, associated with delivering the item to the customer, based on accessing the customer record with the merchant. For example, once the charging platform accesses the customer record, the merchant device may automatically provide the information indicating the delivery status of the item to the charging platform. In some implementations, the merchant device may provide, to the charging platform, an API that the charging platform may use to provide information to identify the purchase of the item (e.g., a dollar amount, the customer record, and/or the like). In such implementations, the charging platform may utilize the API to provide the information, and may receive the information indicating the delivery status of the item based on providing the information.

In some implementations, the charging platform may request the delivery status of the item directly from the customer and the user device. For example, as shown in FIG. 1F, and by reference number 150, the charging platform may request, from the user device, the delivery status of the item. In some implementations, the charging platform may request the delivery status of the item by providing, to the user device, an email requesting the delivery status of the item, by providing, to the user device, a short message service (SMS) message requesting the delivery status of the item, by providing, to the user device, a voice call requesting the delivery status of the item, and/or the like.

In some implementations, the user device may receive, from the charging platform, the request for the delivery status of the item and the customer may utilize the user device to provide the delivery status of the item to the charging device. For example, as further shown in FIG. 1F, and by reference number 155, the charging platform may receive, from the user device, information indicating the delivery status of the item based on the request. In some implementations, the charging platform may receive, from the user device, the delivery status of the item via an email providing the delivery status of the item, may receive, from the user device, the delivery status of the item via a SMS message providing the delivery status of the item, may receive, from the user device, the delivery status of the item via a voice call providing the delivery status of the item, and/or the like.

In some implementations, the charging platform may request the delivery status of the item indirectly from the customer and the user device. For example, as shown in FIG. 1G, and by reference number 160, the charging platform may utilize a browser extension (e.g., or an application that records inputs) with the user device. The charging platform may cause (e.g., with the customer's permission) the browser extension to be installed on the user device, and the browser extension may capture browser inputs provided to a browser application associated with the user device (e.g., by the customer). In some implementations, the customer may utilize the browser application to provide the delivery status of the item.

As further shown in FIG. 1G, and by reference number 165, the charging platform may receive the browser inputs from the browser extension installed on the user device. In some implementations, the charging platform may analyze (e.g., review text of) the browser inputs to identify information contained in the browser inputs, and may identify the delivery status of the item based on analyzing the browser inputs.

In some implementations, the charging platform may periodically (e.g., daily, weekly, and/or the like) check the delivery status of the item with the user device, the merchant device, the courier device, and/or the like in order to determine if the item will be delivered on time. For example, as shown in FIG. 1H, and by reference number 170, the charging platform may provide, to the courier device, a request to check the delivery status of the item. In some implementations, the courier device may receive the request to check the delivery status of the item, and may provide, to the charging platform, information indicating an updated delivery status of the item based on the request. As further shown in FIG. 1H, and by reference number 175, the charging platform may receive, from the courier device, the information indicating an updated delivery status of the item based on the request.

In some implementations, the charging platform may determine that the item was delivered to the customer based on the updated delivery status of the item. In such implementations, the charging platform may post the authorization charge to the record associated with the customer so that the customer may be charged for the purchase. In this way, the charging platform does not charge the customer for the purchase of the item until the item is delivered to the customer.

As shown in FIG. 1I, in some implementations, the charging platform may determine that the item was not delivered to the customer based on the updated delivery status of the item. In such implementations, the charging platform may cancel the authorization charge for the purchase without posting the authorization charge to the customer record. In this way, the charging platform prevents the customer from being charged for a purchase of an item that is not delivered to the customer.

As further shown in FIG. 1I, and by reference number 180, the charging platform may provide, to the merchant and via the merchant device, a request for a charge back based on determining that the item was not delivered to the customer. The merchant device may receive the request for the charge back and may provide, to the charging platform, a charge back for the item that was not delivered to the customer. As further shown in FIG. 1I, and by reference number 185, the charging platform may receive, from the merchant device, the charge back for the item that was not delivered to the customer.

In some implementations, instead of requesting the charge back from the merchant device, the charging platform may provide, to the user device, a charge back form for the customer to send to fill out. In such implementations, the customer may utilize the user device to fill out the charge back form and may cause the user device to provide the charge back form to the charging platform. The charging platform may provide the charge back form to the merchant device and may receive, from the merchant device, the charge back for the item that was not delivered to the customer based on the charge back form.

As shown in FIG. 1J, and by reference number 190, the charging platform may utilize data associated with transactions from multiple customers to identify merchants that deliver items in a timely manner. For example, the charging platform may determine that particular merchants deliver items in a timely manner and may recommend the particular merchants to customers. In some implementations, the charging platform may process the data associated with transactions from multiple customers, with a machine learning model, to identify merchants that deliver items in a timely manner. In some implementations, the machine learning model may include a pattern recognition model that identifies merchants that deliver items in a timely manner.

In some implementations, the charging platform may perform a training operation on the machine learning model with historical data associated with transactions from multiple customers to train the machine learning model to identify merchants that deliver items in a timely manner. The charging platform may separate the historical data associated with transactions from multiple customers into a training set, a validation set, a test set, and/or the like. In some implementations, the charging platform may train the machine learning model using, for example, an unsupervised training procedure and based on the historical data associated with transactions from multiple customers. For example, the charging platform may perform dimensionality reduction to reduce the historical data associated with transactions from multiple customers to a minimum feature set, thereby reducing resources (e.g., processing resources, memory resources, and/or the like) to train the machine learning model, and may apply a classification technique, to the minimum feature set.

In some implementations, the charging platform may use a logistic regression classification technique to determine a categorical outcome (e.g., that particular merchants deliver items in a timely manner). Additionally, or alternatively, the charging platform may use a naive Bayesian classifier technique. In this case, the charging platform may perform binary recursive partitioning to split the historical data associated with transactions from multiple customers into partitions and/or branches, and use the partitions and/or branches to perform predictions (e.g., that particular merchants deliver items in a timely manner). Based on using recursive partitioning, the charging platform may reduce utilization of computing resources relative to manual, linear sorting and analysis of data points, thereby enabling use of thousands, millions, or billions of data points to train the machine learning model, which may result in a more accurate model than using fewer data points.

Additionally, or alternatively, the charging platform may use a support vector machine (SVM) classifier technique to generate a non-linear boundary between data points in the training set. In this case, the non-linear boundary is used to classify test data into a particular class.

Additionally, or alternatively, the charging platform may train the machine learning model using a supervised training procedure that includes receiving input to the machine learning model from a subject matter expert, which may reduce an amount of time, an amount of processing resources, and/or the like to train the machine learning model of activity automatability relative to an unsupervised training procedure. In some implementations, the charging platform may use one or more other model training techniques, such as a neural network technique, a latent semantic indexing technique, and/or the like. For example, the charging platform may perform an artificial neural network processing technique (e.g., using a two-layer feedforward neural network architecture, a three-layer feedforward neural network architecture, and/or the like) to perform pattern recognition with regard to patterns of the historical data associated with transactions from multiple customers. In this case, using the artificial neural network processing technique may improve an accuracy of the trained machine learning model generated by the charging platform by being more robust to noisy, imprecise, or incomplete data, and by enabling the charging platform to detect patterns and/or trends undetectable to human analysts or systems using less complex techniques.

As further shown in FIG. 1J, and by reference number 195, the charging platform may perform one or more actions based on identifying the merchants that deliver items in a timely manner. For example, the charging platform may provide, to the user device, recommendations indicating merchants that deliver items in a timely manner or may not provide recommendations for merchants that do not deliver items in a timely manner. In this way, customers may select merchants that are known to deliver items in a timely manner.

In some implementations, the charging platform may provide, to the merchant device, recommendations indicating courier services that deliver items in a timely manner or may not provide recommendations for courier services that do not deliver items in a timely manner. In this way, merchants may select courier services that are known to deliver items in a timely manner.

In some implementations, the charging platform may prevent customers from conducting transactions with merchants that do not deliver items in a timely manner. For example, the charging platform may not authorize payment for purchases from merchants that do not deliver items in a timely manner. In this way, the charging platform may prevent fraudulent merchants from attempting to steal from customers.

In some implementations, the charging platform may notify customers of an average delivery time associated with a particular merchant (e.g., for merchants that deliver items is a slow manner). In some implementations, the charging platform may cause a security device to add the merchant to a blacklist. In some implementations, the charging platform may cause a security device to block traffic to the merchant's website. In some implementations, the charging platform may cause a security device to provide a warning if a user device accesses the merchant's website. In some implementations, the charging platform may report the courier to the merchant. For example, if a particular courier is regularly delivering items late for a plurality of different merchants, the issue may be the courier rather than the merchant. In some implementations, the charging platform may recommend a different courier for a courier that regularly delivering items late.

In this way, several different stages of the process for delaying payment for a transaction for an item until the item is delivered are automated, which may remove human subjectivity and waste from the process, and which may improve speed and efficiency of the process and conserve computing resources (e.g., processing resources, memory resources, and/or the like). Furthermore, implementations described herein use a rigorous, computerized process to perform tasks or roles that were not previously performed or were previously performed using subjective human intuition or input. For example, currently, there does not exist a technique that automatically delays payment for a transaction for an item until the item is delivered. Finally, automating the process for automatically delaying payment for a transaction for an item until the item is delivered conserves computing resources (e.g., processing resources, memory resources, and/or the like) that would otherwise be wasted in attempting to obtain credit for items that were not delivered.

As indicated above, FIGS. 1A-1J are provided merely as examples. Other examples are possible and may differ from what was described with regard to FIGS. 1A-1J.

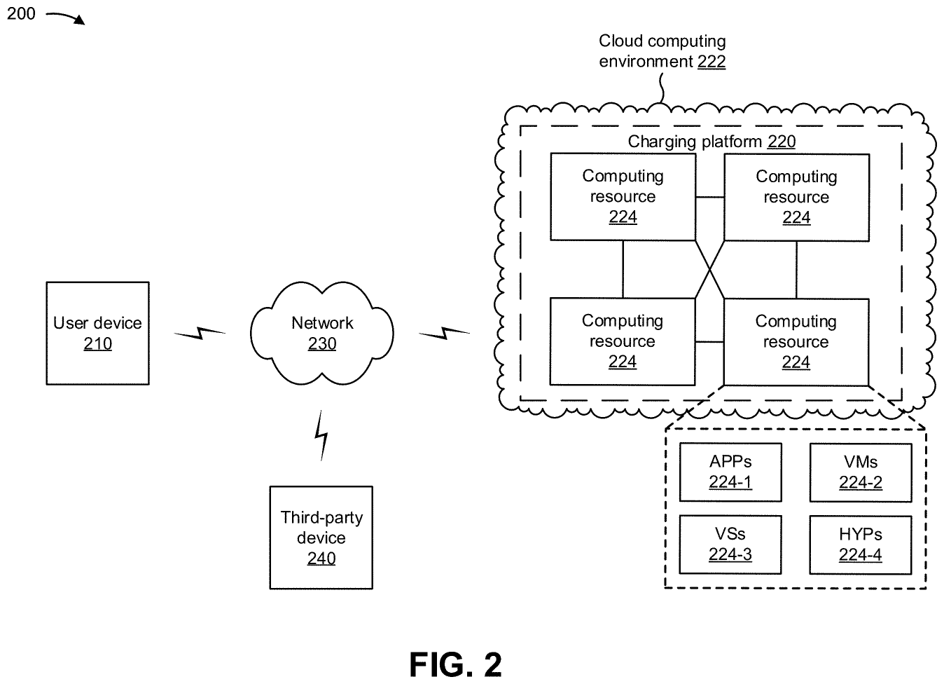

FIG. 2 is a diagram of an example environment 200 in which systems and/or methods, described herein, may be implemented. As shown in FIG. 2, environment 200 may include a user device 210, a charging platform 220, a network 230, and a third-party device 240. Devices of environment 200 may interconnect via wired connections, wireless connections, or a combination of wired and wireless connections.

User device 210 includes one or more devices capable of receiving, generating, storing, processing, and/or providing information, such as information described herein. For example, user device 210 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, user device 210 may receive information from and/or transmit information to charging platform 220.

Charging platform 220 includes one or more devices that automatically delay payment for a transaction for an item until the item is delivered. In some implementations, charging platform 220 may be designed to be modular such that certain software components may be swapped in or out depending on a particular need. As such, charging platform 220 may be easily and/or quickly reconfigured for different uses. In some implementations, charging platform 220 may receive information from and/or transmit information to one or more user devices 210.

In some implementations, as shown, charging platform 220 may be hosted in a cloud computing environment 222. Notably, while implementations described herein describe charging platform 220 as being hosted in cloud computing environment 222, in some implementations, charging platform 220 may not be cloud-based (i.e., may be implemented outside of a cloud computing environment) or may be partially cloud-based.

Cloud computing environment 222 includes an environment that hosts charging platform 220. Cloud computing environment 222 may provide computation, software, data access, storage, etc. services that do not require end-user knowledge of a physical location and configuration of system(s) and/or device(s) that host charging platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host charging platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by user device 210. Application 224-1 may eliminate a need to install and execute the software applications on user device 210. For example, application 224-1 may include software associated with charging platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., a user of user device 210 or an operator of charging platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

Third-party device 240 includes one or more devices capable of receiving, generating, storing, processing, and/or providing information, such as information described herein. For example, third-party device 240 may include a server device, a group of server devices, one or more virtual machines provided in a cloud computing environment, and/or the like. In some implementations, third-party device 240 may include a merchant device (e.g., associated with a merchant) that enables user device 210 to conduct online transactions for items (e.g., products and/or services). In some implementations, third-party device may include a courier device (e.g., associated with a courier service) that enables a merchant to deliver items to customers associated with user devices 210.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

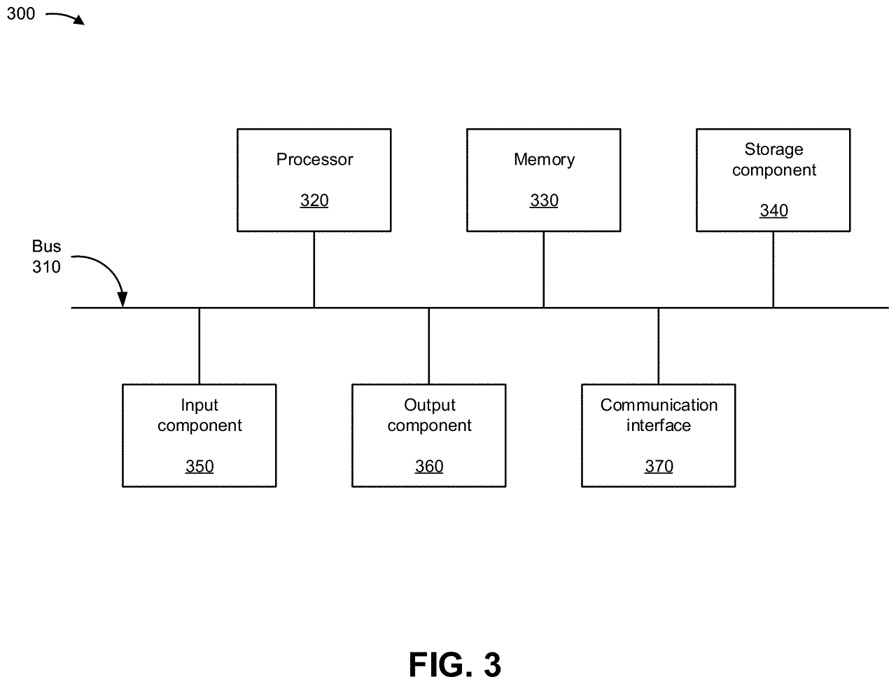

FIG. 3 is a diagram of example components of a device 300. Device 300 may correspond to user device 210, charging platform 220, computing resource 224, and/or third-party device 240. In some implementations, user device 210, charging platform 220, computing resource 224, and/or third-party device 240 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read-only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

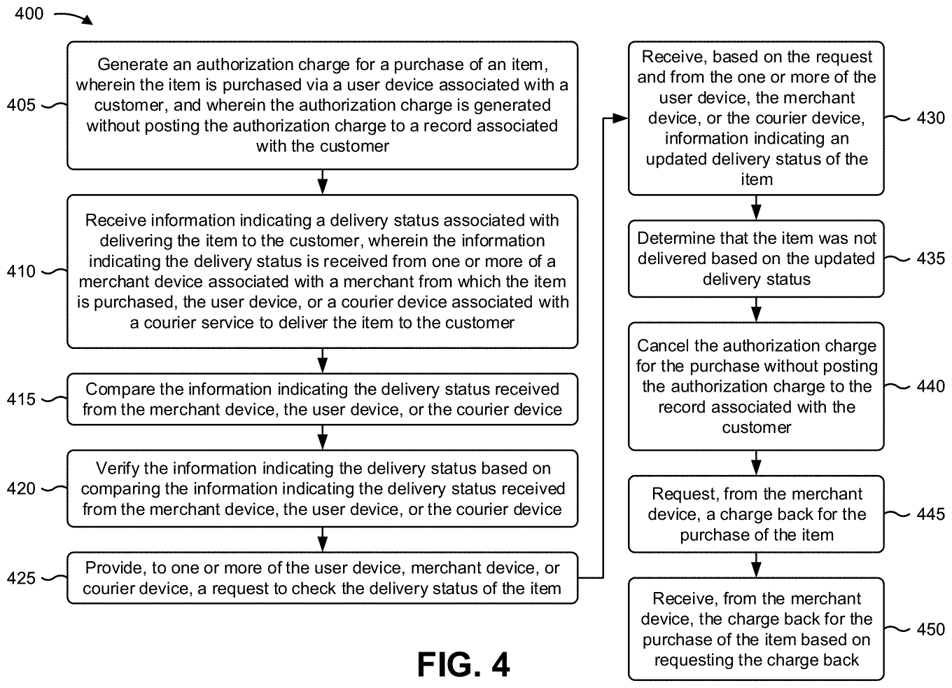

FIG. 4 is a flow chart of an example process 400 for automatically delaying payment for a transaction for an item until the item is delivered. In some implementations, one or more process blocks of FIG. 4 may be performed by a charging platform (e.g., charging platform 220). In some implementations, one or more process blocks of FIG. 4 may be performed by another device or a group of devices separate from or including the charging platform, such as a user device (e.g., user device 210) or a third-party device (e.g., third-party device 240).

As shown in FIG. 4, process 400 may include generating an authorization charge for a purchase of an item, wherein the item is purchased via a user device associated with a customer, and wherein the authorization charge is generated without posting the authorization charge to a record associated with the customer (block 405). For example, the charging platform (e.g., using computing resource 224, processor 320, memory 330, communication interface 370, and/or the like) may generate an authorization charge for a purchase of an item, as described above in connection with FIGS. 1A-2. In some implementations, the item may be purchased via a user device associated with a customer, and the authorization charge may be generated without posting the authorization charge to a record associated with the customer.

As further shown in FIG. 4, process 400 may include receiving information indicating a delivery status associated with delivering the item to the customer, wherein the information indicating the delivery status is received from one or more of a merchant device associated with a merchant from which the item is purchased, the user device, or a courier device associated with a courier service to deliver the item to the customer (block 410). For example, the charging platform (e.g., using computing resource 224, processor 320, communication interface 370, and/or the like) may receive information indicating a delivery status associated with delivering the item to the customer, as described above in connection with FIGS. 1A-2. In some implementations, the information indicating the delivery status may be received from one or more of a merchant device associated with a merchant from which the item is purchased, the user device, or a courier device associated with a courier service to deliver the item to the customer.

As further shown in FIG. 4, process 400 may include comparing the information indicating the delivery status received from the merchant device, the user device, or the courier device (block 415). For example, the charging platform (e.g., using computing resource 224, processor 320, storage component 340, and/or the like) may compare the information indicating the delivery status received from the merchant device, the user device, or the courier device, as described above in connection with FIGS. 1A-2.

As further shown in FIG. 4, process 400 may include verifying the information indicating the delivery status based on comparing the information indicating the delivery status received from the merchant device, the user device, or the courier device (block 420). For example, the charging platform (e.g., using computing resource 224, processor 320, memory 330, and/or the like) may verify the information indicating the delivery status based on comparing the information indicating the delivery status received from the merchant device, the user device, or the courier device, as described above in connection with FIGS. 1A-2.

As further shown in FIG. 4, process 400 may include providing, to one or more of the user device, the merchant device, or the courier device, a request to check the delivery status of the item (block 425). For example, the charging platform (e.g., using computing resource 224, processor 320, communication interface 370, and/or the like) may provide, to one or more of the user device, the merchant device, or the courier device, a request to check the delivery status of the item, as described above in connection with FIGS. 1A-2.

As further shown in FIG. 4, process 400 may include receiving, based on the request, and from the one or more of the user device, the merchant device, or the courier device, information indicating an updated delivery status of the item (block 430). For example, the charging platform (e.g., using computing resource 224, processor 320, communication interface 370, and/or the like) may receive, based on the request, and from the one or more of the user device, the merchant device, or the courier device, information indicating an updated delivery status of the item, as described above in connection with FIGS. 1A-2.

As further shown in FIG. 4, process 400 may include determining that the item was not delivered based on the updated delivery status (block 435). For example, the charging platform (e.g., using computing resource 224, processor 320, memory 330, and/or the like) may determine that the item was not delivered based on the updated delivery status, as described above in connection with FIGS. 1A-2.

As further shown in FIG. 4, process 400 may include canceling the authorization charge for the purchase without posting the authorization charge to the record associated with the customer (block 440). For example, the charging platform (e.g., using computing resource 224, processor 320, storage component 340, and/or the like) may cancel the authorization charge for the purchase without posting the authorization charge to the record associated with the customer, as described above in connection with FIGS. 1A-2.

As further shown in FIG. 4, process 400 may include requesting, from the merchant device, a charge back for the purchase of the item (block 445). For example, the charging platform (e.g., using computing resource 224, processor 320, memory 330, communication interface 370, and/or the like) may request, from the merchant device, a charge back for the purchase of the item, as described above in connection with FIGS. 1A-2.

As further shown in FIG. 4, process 400 may include receiving, from the merchant device, the charge back for the purchase of the item based on requesting the charge back (block 450). For example, the charging platform (e.g., using computing resource 224, processor 320, communication interface 370, and/or the like) may receive, from the merchant device, the charge back for the purchase of the item based on requesting the charge back, as described above in connection with FIGS. 1A-2.

Process 400 may include additional implementations, such as any single implementation or any combination of implementations described below and/or described with regard to any other process described herein.

In some implementations, the charging platform may identify the merchant as unreliable based on determining that the item was not delivered by the merchant, and may perform one or more actions, with respect to the merchant, based on identifying the merchant as unreliable. In some implementations, when the information indicating the delivery status is received from the user device, the charging platform may receive, from the user device, transaction information associated with the purchase of the item, may create a template to identify the information indicating the delivery status in the transaction information, and may identify the information indicating the delivery status based on the template.

In some implementations, the information indicating the delivery status may be provided via a tracking number associated with delivering the item to the customer. In some implementations, when the information indicating the delivery status is received from the merchant device, the charging platform may receive, from the user device, information indicating permission to access a customer record, of the customer, with the merchant device, may access the customer record with the merchant device based on the information indicating the permission to access the customer record, and may receive, from the merchant device, the information indicating the delivery status based on accessing the customer record with the merchant device.

In some implementations, the charging platform may provide, to the user device, a charge back form, where the user device is to provide a completed charge back form to the charging platform for requesting the charge back from the merchant device for the purchase of the item. In some implementations, when the information indicating the delivery status is received from the user device, the charging platform may utilize a browser extension with the user device, may receive browser inputs by the customer from the browser extension, and may identify the information indicating the delivery status based on the browser inputs.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

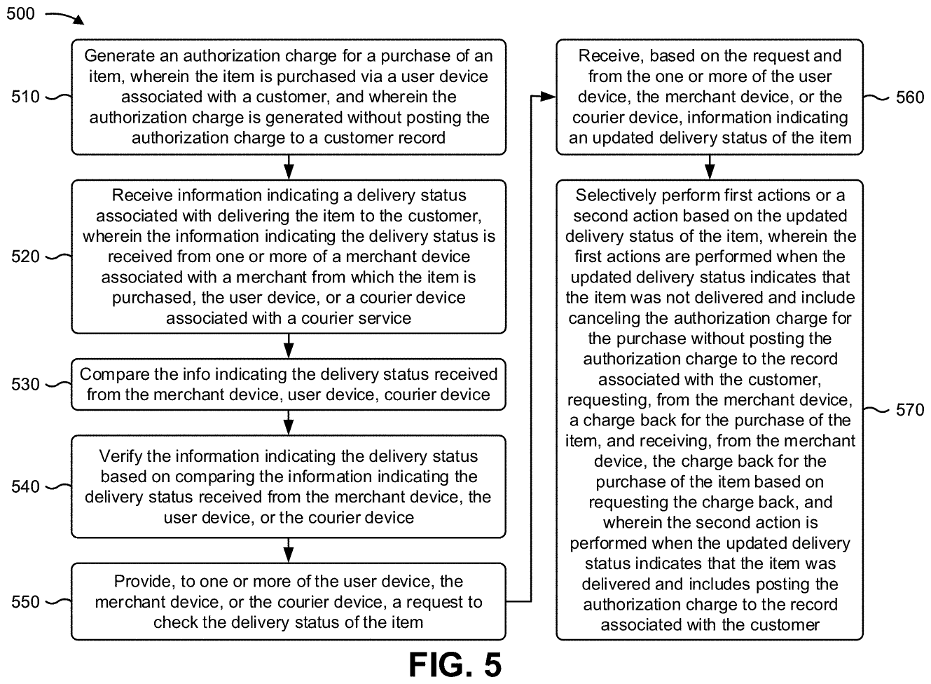

FIG. 5 is a flow chart of an example process 500 for automatically delaying payment for a transaction for an item until the item is delivered. In some implementations, one or more process blocks of FIG. 5 may be performed by a charging platform (e.g., charging platform 220). In some implementations, one or more process blocks of FIG. 5 may be performed by another device or a group of devices separate from or including the charging platform, such as a user device (e.g., user device 210) or a third-party device (e.g., third-party device 240).

As shown in FIG. 5, process 500 may include generating an authorization charge for a purchase of an item, wherein the item is purchased via a user device associated with a customer, and wherein the authorization charge is generated without posting the authorization charge to a record associated with the customer (block 510). For example, the charging platform (e.g., using computing resource 224, processor 320, memory 330, communication interface 370, and/or the like) may generate an authorization charge for a purchase of an item, as described above in connection with FIGS. 1A-2. In some implementations, the item may be purchased via a user device associated with a customer, and the authorization charge may be generated without posting the authorization charge to a record associated with the customer.

As further shown in FIG. 5, process 500 may include receiving information indicating a delivery status associated with delivering the item to the customer, wherein the information indicating the delivery status is received from one or more of a merchant device associated with a merchant from which the item is purchased, the user device, or a courier device associated with a courier service to deliver the item to the customer (block 520). For example, the charging platform (e.g., using computing resource 224, processor 320, communication interface 370, and/or the like) may receive information indicating a delivery status associated with delivering the item to the customer, as described above in connection with FIGS. 1A-2. In some implementations, the information indicating the delivery status may be received from one or more of a merchant device associated with a merchant from which the item is purchased, the user device, or a courier device associated with a courier service to deliver the item to the customer.

As further shown in FIG. 5, process 500 may include comparing the information indicating the delivery status received from the merchant device, the user device, or the courier device (block 530). For example, the charging platform (e.g., using computing resource 224, processor 320, memory 330, and/or the like) may compare the information indicating the delivery status received from the merchant device, the user device, or the courier device, as described above in connection with FIGS. 1A-2.

As further shown in FIG. 5, process 500 may include verifying the information indicating the delivery status based on comparing the information indicating the delivery status received from the merchant device, the user device, or the courier device (block 540). For example, the charging platform (e.g., using computing resource 224, processor 320, storage component 340, and/or the like) may verify the information indicating the delivery status based on comparing the information indicating the delivery status received from the merchant device, the user device, or the courier device, as described above in connection with FIGS. 1A-2.

As further shown in FIG. 5, process 500 may include providing, to one or more of the user device, the merchant device, or the courier device, a request to check the delivery status of the item (block 550). For example, the charging platform (e.g., using computing resource 224, processor 320, communication interface 370, and/or the like) may provide, to one or more of the user device, the merchant device, or the courier device, a request to check the delivery status of the item, as described above in connection with FIGS. 1A-2.

As further shown in FIG. 5, process 500 may include receiving, based on the request and from the one or more of the user device, the merchant device, or the courier device, information indicating an updated delivery status of the item (block 560). For example, the charging platform (e.g., using computing resource 224, processor 320, memory 330, communication interface 370, and/or the like) may receive, based on the request and from the one or more of the user device, the merchant device, or the courier device, information indicating an updated delivery status of the item, as described above in connection with FIGS. 1A-2.

As further shown in FIG. 5, process 500 may include selectively performing first actions or a second action based on the updated delivery status of the item, wherein the first actions are performed when the updated delivery status indicates that the item was not delivered and include canceling the authorization charge for the purchase without posting the authorization charge to the record associated with the customer, requesting, from the merchant device, a charge back for the purchase of the item, and receiving, from the merchant device, the charge back for the purchase of the item based on requesting the charge back, and wherein the second action is performed when the updated delivery status indicates that the item was delivered and includes posting the authorization charge to the record associated with the customer (block 570). For example, the charging platform (e.g., using computing resource 224, processor 320, memory 330, communication interface 370, and/or the like) may selectively perform first actions or a second action based on the updated delivery status of the item, as described above in connection with FIGS. 1A-2. In some implementations, the first actions may be performed when the updated delivery status indicates that the item was not delivered, and may include canceling the authorization charge for the purchase without posting the authorization charge to the record associated with the customer, requesting, from the merchant device, a charge back for the purchase of the item, and receiving, from the merchant device, the charge back for the purchase of the item based on requesting the charge back. In some implementations, the second action may be performed when the updated delivery status indicates that the item was delivered and may include posting the authorization charge to the record associated with the customer.

Process 500 may include additional implementations, such as any single implementation or any combination of implementations described below and/or described with regard to any other process described herein.

In some implementations, the information indicating the delivery status may be provided via a tracking number associated with delivering the item to the customer. In some implementations, the charging platform may identify the merchant as unreliable when the updated delivery status indicates that the item was not delivered, and may perform one or more actions, with respect to the merchant, based on identifying the merchant as unreliable.

In some implementations, when the information indicating the delivery status is received from the user device, the charging platform may receive, from the user device, transaction information associated with the purchase of the item, may perform natural language processing on the transaction information, and may identify the information indicating the delivery status based on performing the natural language processing on the transaction information.

In some implementations, when the updated delivery status indicates that the item was not delivered, the charging platform may provide, to the user device, a charge back form, where the user device is to provide a completed charge back form to the charging platform for requesting the charge back from the merchant device for the purchase of the item.

In some implementations, when the information indicating the delivery status is received from the merchant device, the charging platform may receive, from the user device, information indicating permission to access a customer record, of the customer, with the merchant device, may access the customer record with the merchant device based on the information indicating the permission to access the customer record, and may receive, from the merchant device, the information indicating the delivery status based on accessing the customer record with the merchant device.

In some implementations, when the information indicating the delivery status is received from the user device, the charging platform may utilize a browser extension with the user device, may receive browser inputs by the customer from the browser extension, and may identify the information indicating the delivery status based on the browser inputs.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

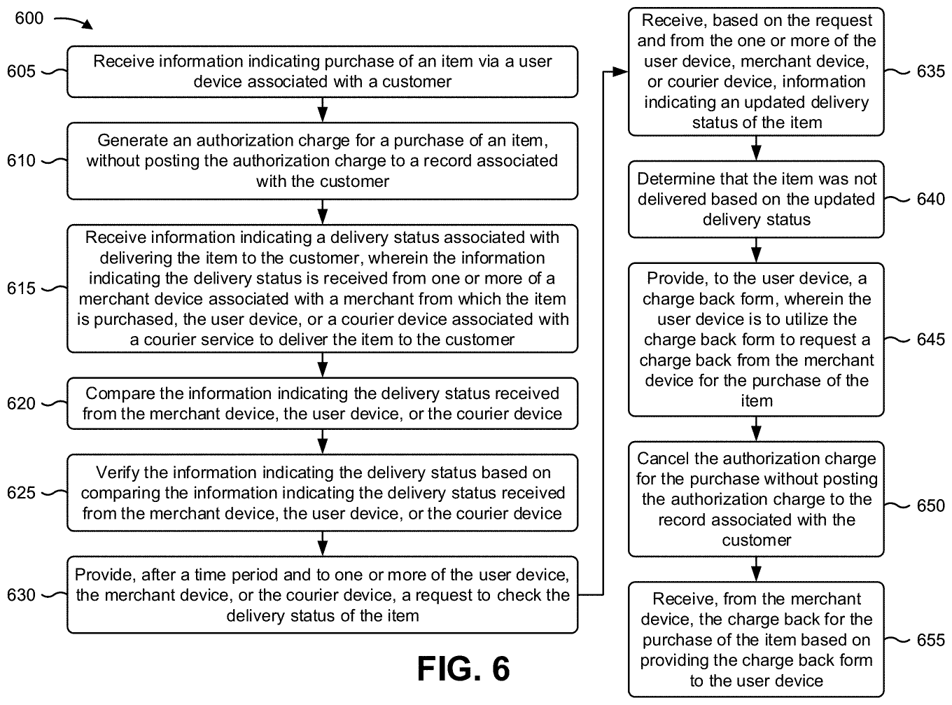

FIG. 6 is a flow chart of an example process 600 for automatically delaying payment for a transaction for an item until the item is delivered. In some implementations, one or more process blocks of FIG. 6 may be performed by a charging platform (e.g., charging platform 220). In some implementations, one or more process blocks of FIG. 6 may be performed by another device or a group of devices separate from or including the charging platform, such as a user device (e.g., user device 210) or a third-party device (e.g., third-party device 240).

As shown in FIG. 6, process 600 may include receiving information indicating purchase of an item via a user device associated with a customer (block 605). For example, the charging platform (e.g., using computing resource 224, processor 320, communication interface 370, and/or the like) may receive information indicating purchase of an item via a user device associated with a customer, as described above in connection with FIGS. 1A-2.

As further shown in FIG. 6, process 600 may include generating an authorization charge for a purchase of an item, without posting the authorization charge to a record associated with the customer (block 610). For example, the charging platform (e.g., using computing resource 224, processor 320, storage component 340, communication interface 370, and/or the like) may generate an authorization charge for a purchase of an item, without posting the authorization charge to a record associated with the customer, as described above in connection with FIGS. 1A-2.

As further shown in FIG. 6, process 600 may include receiving information indicating a delivery status associated with delivering the item to the customer, wherein the information indicating the delivery status is received from one or more of a merchant device associated with a merchant from which the item is purchased, the user device, or a courier device associated with a courier service to deliver the item to the customer (block 615). For example, the charging platform (e.g., using computing resource 224, processor 320, communication interface 370, and/or the like) may receive information indicating a delivery status associated with delivering the item to the customer, as described above in connection with FIGS. 1A-2. In some implementations, the information indicating the delivery status may be received from one or more of a merchant device associated with a merchant from which the item is purchased, the user device, or a courier device associated with a courier service to deliver the item to the customer.

As further shown in FIG. 6, process 600 may include comparing the information indicating the delivery status received from the merchant device, the user device, or the courier device (block 620). For example, the charging platform (e.g., using computing resource 224, processor 320, memory 330, and/or the like) may compare the information indicating the delivery status received from the merchant device, the user device, or the courier device, as described above in connection with FIGS. 1A-2.

As further shown in FIG. 6, process 600 may include verifying the information indicating the delivery status based on comparing the information indicating the delivery status received from the merchant device, the user device, or the courier device (block 625). For example, the charging platform (e.g., using computing resource 224, processor 320, memory 330, and/or the like) may verify the information indicating the delivery status based on comparing the information indicating the delivery status received from the merchant device, the user device, or the courier device, as described above in connection with FIGS. 1A-2.

As further shown in FIG. 6, process 600 may include providing, after a time period and to one or more of the user device, the merchant device, or the courier device, a request to check the delivery status of the item (block 630). For example, the charging platform (e.g., using computing resource 224, processor 320, memory 330, communication interface 370, and/or the like) may provide, after a time period and to one or more of the user device, the merchant device, or the courier device, a request to check the delivery status of the item, as described above in connection with FIGS. 1A-2.

As further shown in FIG. 6, process 600 may include receiving, based on the request and from the one or more of the user device, the merchant device, or the courier device, information indicating an updated delivery status of the item (block 635). For example, the charging platform (e.g., using computing resource 224, processor 320, communication interface 370, and/or the like) may receive, based on the request and from the one or more of the user device, the merchant device, or the courier device, information indicating an updated delivery status of the item, as described above in connection with FIGS. 1A-2.

As further shown in FIG. 6, process 600 may include determining that the item was not delivered based on the updated delivery status (block 640). For example, the charging platform (e.g., using computing resource 224, processor 320, memory 330, and/or the like) may determine that the item was not delivered based on the updated delivery status, as described above in connection with FIGS. 1A-2.

As further shown in FIG. 6, process 600 may include providing, to the user device, a charge back form, wherein the user device is to provide a completed charge back form to the device for requesting a charge back from the merchant device for the purchase of the item (block 645). For example, the charging platform (e.g., using computing resource 224, processor 320, memory 330, communication interface 370, and/or the like) may provide, to the user device, a charge back form, as described above in connection with FIGS. 1A-2. In some implementations, the user device may provide a completed charge back form to the charging platform for requesting a charge back from the merchant device for the purchase of the item.

As further shown in FIG. 6, process 600 may include canceling the authorization charge for the purchase without posting the authorization charge to the record associated with the customer (block 650). For example, the charging platform (e.g., using computing resource 224, processor 320, storage component 340, communication interface 370, and/or the like) may cancel the authorization charge for the purchase without posting the authorization charge to the record associated with the customer, as described above in connection with FIGS. 1A-2.

As further shown in FIG. 6, process 600 may include receiving, from the merchant device, the charge back for the purchase of the item based on providing the charge back form to the user device (block 655). For example, the charging platform (e.g., using computing resource 224, processor 320, communication interface 370, and/or the like) may receive, from the merchant device, the charge back for the purchase of the item based on providing the charge back form to the user device, as described above in connection with FIGS. 1A-2.

Process 600 may include additional implementations, such as any single implementation or any combination of implementations described below and/or described with regard to any other process described herein.

In some implementations, the charging platform may request, from the merchant device, the charge back for the purchase of the item. In some implementations, when the information indicating the delivery status is received from the user device, the charging platform may receive, from the user device, transaction information associated with the purchase of the item, may create a template to identify the information indicating the delivery status in the transaction information, and may identify the information indicating the delivery status based on the template.

In some implementations, when the information indicating the delivery status is received from the courier device, the charging platform may identify the merchant as unreliable based on determining that the item was not delivered by the merchant, and may perform one or more actions, with respect to the merchant, based on identifying the merchant as unreliable.

In some implementations, when the information indicating the delivery status is received from the merchant device, the charging platform may receive, from the user device, information indicating permission to access a customer record, of the customer, with the merchant device, may access the customer record with the merchant device based on the information indicating the permission to access the customer record, and may receive, from the merchant device, the information indicating the delivery status based on accessing the customer record with the merchant device.

In some implementations, when the information indicating the delivery status is received from the user device, the charging platform may utilize a browser extension with the user device, may receive browser inputs by the customer from the browser extension, and may identify the information indicating the delivery status based on the browser inputs.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method, comprising:
generating, by a device, an authorization charge for a purchase of an item,
wherein the item is purchased via a user device associated with a customer, and
wherein the authorization charge is generated without posting the authorization charge to a record associated with the customer;
receiving, by the device, information indicating a delivery status associated with delivering the item to the customer,
wherein the information indicating the delivery status is received from one or more of:
a merchant device associated with a merchant from which the item is purchased,
the user device, or
a courier device associated with a courier service to deliver the item to the customer;
receiving, by the device and from the user device, transaction information associated with the purchase of the item;
creating, by the device and based on a format of the transaction information, a template to identify the information indicating the delivery status in the transaction information,
the format being different from other formats of other transaction information associated with other merchants;
identifying, by the device, the information indicating the delivery status based on the template;
comparing, by the device, the information indicating the delivery status received from the merchant device, the user device, or the courier device;
verifying, by the device, the information indicating the delivery status based on comparing the information indicating the delivery status received from the merchant device, the user device, or the courier device;
providing, by the device and to the merchant device, a request, via an application programming interface (API) of the merchant, to check the delivery status of the item,
the request including information identifying the purchase;
receiving, by the device, based on the request, and via the API of the merchant, information indicating an updated delivery status of the item;
determining, by the device, that the item was not delivered based on the updated delivery status;
canceling, by the device, the authorization charge for the purchase without posting the authorization charge to the record associated with the customer;
requesting, by the device and from the merchant device, a charge back for the purchase of the item; and
receiving, by the device and from the merchant device, the charge back for the purchase of the item based on requesting the charge back.

2. The method of claim 1, wherein the method further comprises:
identifying the merchant as unreliable based on determining that the item was not delivered by the merchant; and
performing one or more actions, with respect to the merchant, based on identifying the merchant as unreliable.

3. (canceled)

4. The method of claim 1, wherein the information indicating the delivery status is provided via a tracking number associated with delivering the item to the customer.

5. The method of claim 1, wherein, when the information indicating the delivery status is received from the merchant device, the method further comprises:
receiving, from the user device, information indicating permission to access a customer record, of the customer, with the merchant device;
accessing the customer record with the merchant device based on the information indicating the permission to access the customer record; and
receiving, from the merchant device, the information indicating the delivery status based on accessing the customer record with the merchant device.

6. The method of claim 1, wherein the method further comprises:
providing, to the user device, a charge back form,
wherein the user device is to provide a completed charge back form to the device for requesting the charge back from the merchant device for the purchase of the item.

7. The method of claim 1, wherein, when the information indicating the delivery status is received from the user device, the method further comprises:
utilizing a browser extension with the user device;
receiving browser inputs by the customer from the browser extension; and
identifying the information indicating the delivery status based on the browser inputs.

8. A device, comprising:
one or more memories; and
one or more processors operatively connected to the one or more memories and configured to:
generate an authorization charge for a purchase of an item,
wherein the item is purchased via a user device associated with a customer, and
wherein the authorization charge is generated without posting the authorization charge to a record associated with the customer;
receive information indicating a delivery status associated with delivering the item to the customer,
wherein the information indicating the delivery status is received from one or more of:
a merchant device associated with a merchant from which the item is purchased,
the user device, or
a courier device associated with a courier service to deliver the item to the customer;
receive, from the user device, transaction information associated with the purchase of the item;
create, based on a format of the transaction information, a template to identify the information indicating the delivery status in the transaction information,
the format being different from other formats of other transaction information associated with other merchants;
identify the information indicating the delivery status based on the template;
compare the information indicating the delivery status received from the merchant device, the user device, or the courier device;
verify the information indicating the delivery status based on comparing the information indicating the delivery status received from the merchant device, the user device, or the courier device;
provide, to the merchant device, a request, via an application programming interface (API) of the merchant, to check the delivery status of the item,
the request including information identifying the purchase;
receive, based on the request and via the API of the merchant, information indicating an updated delivery status of the item; and
selectively perform first actions or a second action based on the updated delivery status of the item,
wherein the first actions are performed when the updated delivery status indicates that the item was not delivered and include:
canceling the authorization charge for the purchase without posting the authorization charge to the record associated with the customer,
requesting, from the merchant device, a charge back for the purchase of the item, and
receiving, from the merchant device, the charge back for the purchase of the item based on requesting the charge back, and
wherein the second action is performed when the updated delivery status indicates that the item was delivered and includes:
posting the authorization charge to the record associated with the customer.

9. The device of claim 8, wherein the information indicating the delivery status is provided via a tracking number associated with delivering the item to the customer.

10. The device of claim 8, wherein the one or more processors are further configured to:
identify the merchant as unreliable when the updated delivery status indicates that the item was not delivered; and
perform one or more actions, with respect to the merchant, based on identifying the merchant as unreliable.

11. The device of claim 8, wherein, when the information indicating the delivery status is received from the user device, the one or more processors are further configured to:
receive, from the user device, transaction information associated with the purchase of the item;
perform natural language processing on the transaction information; and
identify the information indicating the delivery status based on performing the natural language processing on the transaction information.

12. The device of claim 8, wherein, when the updated delivery status indicates that the item was not delivered, the one or more processors are further configured to:
provide, to the user device, a charge back form,
wherein the user device is to provide a completed charge back form to the device for requesting the charge back from the merchant device for the purchase of the item.

13. The device of claim 8, wherein, when the information indicating the delivery status is received from the merchant device, the one or more processors are further configured to:
receive, from the user device, information indicating permission to access a customer record, of the customer, with the merchant device;
access the customer record with the merchant device based on the information indicating the permission to access the customer record; and
receive, from the merchant device, the information indicating the delivery status based on accessing the customer record with the merchant device.

14. The device of claim 8, wherein, when the information indicating the delivery status is received from the user device, the one or more processors are further configured to:
utilize a browser extension with the user device;
receive browser inputs by the customer from the browser extension; and
identify the information indicating the delivery status based on the browser inputs.

15. A non-transitory computer-readable medium storing instructions, the instructions comprising:
one or more instructions that, when executed by one or more processors of a device, cause the one or more processors to:
receive information indicating a purchase of an item via a user device associated with a customer;
generate an authorization charge for the purchase of the item, without posting the authorization charge to a record associated with the customer;
receive information indicating a delivery status associated with delivering the item to the customer,
wherein the information indicating the delivery status is received from one or more of:
a merchant device associated with a merchant from which the item is purchased,
the user device, or
a courier device associated with a courier service to deliver the item to the customer;
receive, from the user device, transaction information associated with the purchase of the item;
create, based on a format of the transaction information, a template to identify the information indicating the delivery status in the transaction information,
the format being different from other formats of other transaction information associated with other merchants;
identify the information indicating the delivery status based on the template;
compare the information indicating the delivery status received from the merchant device, the user device, or the courier device;
verify the information indicating the delivery status based on comparing the information indicating the delivery status received from the merchant device, the user device, or the courier device;
provide, after a time period and to the merchant device, a request, via an application programming interface (API) of the merchant, to check the delivery status of the item,
the request including information identifying the purchase;
receive, based on the request and via the API of the merchant, information indicating an updated delivery status of the item;
determine that the item was not delivered based on the updated delivery status;
provide, to the user device, a charge back form,
wherein the user device is to provide a completed charge back form to the device for requesting a charge back from the merchant device for the purchase of the item;
cancel the authorization charge for the purchase without posting the authorization charge to the record associated with the customer; and
receive, from the merchant device, the charge back for the purchase of the item based on providing the charge back form to the user device.

16. The non-transitory computer-readable medium of claim 15, wherein the instructions further comprise:
one or more instructions that, when executed by the one or more processors, cause the one or more processors to:
request, from the merchant device, the charge back for the purchase of the item.

17. (canceled)

18. The non-transitory computer-readable medium of claim 15, wherein, when the information indicating the delivery status is received from the courier device, the instructions further comprise:
one or more instructions that, when executed by the one or more processors, cause the one or more processors to:
identify the merchant as unreliable based on determining that the item was not delivered by the merchant; and
perform one or more actions, with respect to the merchant, based on identifying the merchant as unreliable.

19. The non-transitory computer-readable medium of claim 15, wherein, when the information indicating the delivery status is received from the merchant device, the instructions further comprise:
one or more instructions that, when executed by the one or more processors, cause the one or more processors to:
receive, from the user device, information indicating permission to access a customer record, of the customer, with the merchant device;
access the customer record with the merchant device based on the information indicating the permission to access the customer record; and
receive, from the merchant device, the information indicating the delivery status based on accessing the customer record with the merchant device.

20. The non-transitory computer-readable medium of claim 15, wherein, when the information indicating the delivery status is received from the user device, the instructions further comprise:
one or more instructions that, when executed by the one or more processors, cause the one or more processors to:
utilize a browser extension with the user device;
receive browser inputs by the customer from the browser extension; and
identify the information indicating the delivery status based on the browser inputs.

21. The non-transitory computer-readable medium of claim 15, wherein the instructions further comprise:
one or more instructions that, when executed by the one or more processors, cause the one or more processors to:
train a machine learning model, using historical data and the transaction information, to identify merchants that deliver items in a timely manner,
the historical data including:
historical transaction data associated with transactions associated with other merchants.

22. The method of claim 1, wherein receiving the transaction information comprises:
receiving the transaction information from a browser extension installed on the user device.
